(19) United States
(12) Patent Application Publication
(10) Pub. No.: US 2013/0175894 A1
(43) Pub. Date: Jul. 11, 2013

(54) DISK TYPE MAGNETIC GENERATOR

(71) Applicant: Hui-Lin CHEN, New Taipei City (TW)

(72) Inventor: Hui-Lin CHEN, New Taipei City (TW)

(21) Appl. No.: 13/733,851

(22) Filed: Jan. 3, 2013

(30) Foreign Application Priority Data
Jan. 10, 2012 (TW) 101100912

(51) Int. Cl. H02K 1/27

(52) U.S. Cl. CPC H02K 1/2793
USPC 310/114

(57) ABSTRACT

A disk type magnetic generator is a core-free magnetic generator including a shaft connected, in series, to a first rotor, a stator, and a second rotor or a core-included magnetic generator including a rotor and a stator connected in series. The rotor has a surface that is positioned against a stator plate and includes a number of flat-plate magnets arranged in a single circle and each forming an inclination angle with respect to a radius of rotor plate. The rotor plate alternatively includes multiple groups of magnets rotatably mounted on the same plate and arranged in concentric circles. The rotor alternatively includes multiple groups of magnets rotatably mounted in a diameter expansion direction and arranged in concentric circles. Alternatively, a combined assembly of a rotor and a stator that are connected in series by a driven shaft is provided with a rotatably connected weight ring in a diameter expansion direction.

### (a) TECHNICAL FIELD OF THE INVENTION

The present invention generally relates to a disk type magnetic generator, and more particular to a core-free magnetic generator or a core-included magnetic power generator, which comprises a rotor having a surface positioned against a stator plate comprising a number of magnets that are in a flat plate form and are arranged in a single circle to each form an inclination angle with respect to a radius of a rotor plate; a rotor plate carrying on the same plate or in a diameter expansion direction a number of magnets that are arranged in multiple concentric groups of which the purposes is to provide a novel disk type magnetic generator that is operable to generate electrical power at an extremely low rotational speed and low torque, is economic in building expense, enables continuous operation and can be set in parallel connection in generating power, provides a simple, economic, and stable power supply system, and has low cost for both installation and maintenance.

### (b) DESCRIPTION OF THE PRIOR ART

A conventional disk type magnetic generator (9) is classified in two categories, including one with an iron core and one without an iron core. The iron core free disk type magnetic generator (9) (see FIG. 1) is structured by comprising a motor-coupled shaft (31) that is connected, in series, to a first rotor (2), a stator (1), and a second rotor (2). The stator (1) comprises a stator plate (10) that forms, centrally, a stator plate bore (11) and comprises a number of coil holes (15) that are arranged in a single circle and receive and retain therein the same number of coils (12). The first rotor (2) and the second rotor (2) are respectively formed of two rotor plates (20) each of which forms, centrally, a rotor plate bore (21) and comprises the same number of magnet holes (25) that are arranged in a single circle to correspond to the single circle of the coil holes (15) of the stator plate (10) and receive and retain therein the same number of magnets (22). The rotor plate bores (21) of the two rotor plates (20) each have a circumference along which an outward-projecting raised rim (26) is formed. Each of the raised rims (26) has a cylindrical body forming a pin hole (33) that extends radially through an axis of the cylindrical body. The shaft (31) is arranged to connect, in series, the first rotor (2), the stator (1) that has a central stator plate bore (11) receiving and retaining a bearing (3), and the second rotor (2). Two pins (32) are respectively fit in the pin holes (33) formed in the cylindrical bodies of the raised rims (26) of the first rotor (2) and the second rotor (2) and penetrate through the shaft (31) so as to have the first rotor (2), the bearing (3), and the second rotor (2) fixed to and coaxial with and rotatable in unison with the shaft (31). The inside recesses of the raised rims (26) of the first rotor (2) and the second rotor (2) are made greater than a bearing space (30) of the bearing (3) (see FIG. 2). The shaft (31), after being connected in series to the first rotor (2), the stator (1), and the second rotor (2), is assembled with an enclosure (90) and a bottom base (91). When driven to rotate, the shaft (31) causes the first rotor (2), the bearing (3), and the second rotor (2) to coaxially rotate thereby generating electrical power. Due to the bearing (3) retained in the central stator plate bore (11), the stator (1) is kept stationary (because an inner race of the bearing (3) is attached to the shaft (31) to rotate in unison therewith, while an outer race is kept fixed due to rolling balls) and is thus allowed to connect a power cable (92) that extends through the enclosure (90) for transmission of electricity (see FIG. 3). Another category of disk type magnetic generator (9) that includes an iron core (see FIG. 4) is structured by comprising a shaft (31) that is connected, in series, to a rotor (2) and a stator (1). The stator (1) comprises a stator plate (10) that forms, centrally, a stator plate bore (11) and comprises a number of coil slots (17) that are arranged in a single circle along an outer annular body thereof with multiple ones of the coil slots (17) being wound around by a corresponding coil (12). Each of the wound coils (12) has a surface positioned against a rotor plate (20) and is provided with one of silicon steel plates (16) that are distributed circumferentially. The rotor (2) comprises a the rotor plate (20) that forms, centrally, a rotor plate bore (21) and comprises the same number of magnet holes (25) that are arranged in a single circle corresponding to the single circle of coil slots (17) of the stator plate (10) and receive and retain therein the same number of magnets (22). The rotor plate bore (21) of the rotor plate (20) has a circumference along which an outward-projecting raised rim (26) is formed. The raised rim (26) of the rotor plate (20) has a cylindrical body forming a pin hole (33) that extends radially through an axis of the cylindrical body. The shaft (31) that is to be driven is arranged to connect, in series, the rotor (2) and the stator (1) that has a central stator plate bore (11) receiving and retaining a bearing (3). A pin (32) is fit in the pin hole (33) formed in the cylindrical body of the raised rim (26) of the rotor (2) and penetrates through the shaft (31) so as to have the rotor (2) and the bearing (3) fixed to and coaxial and rotatable in unison with the shaft (31). The inside recess of the raised rim (26) of the rotor (2) is made greater than a bearing space (30) of the bearing (3). When driven, the shaft (31) causes the rotor (2) and the bearing (3) to coaxially rotate thereby generating electrical power. Due to the bearing (3) retained in the central stator plate bore (11), the stator (1) is kept stationary and is thus allowed to connect a power cable (92) for transmission of electricity (see FIG. 5).

### SUMMARY OF THE INVENTION

Nowadays, the disk type magnetic generator (9) is considered a new star of the future energy development. Most people place their hope on electrical power converted from renewable resources (such as solar energy, wind power, hydraulic power, and tidal power) due to the time pressure for exhaustion of fossil energy and the nuclear events recently occurring in Japan. Honestly, diversification of energy resources is the currently trend of the policy of each country. However, besides certain achievement of gaining energy being made for hydraulic power generation, other types of natural resources are all in the stage of being developed. It is noted that hydraulic energy is not a natural condition for every country or area in the world. Solar energy, although being put in development in each country, is of high expense for the solar panel. Heat absorption facility installed in a large area does not pay itself off. In addition, the solar energy facility is of a limited lifespan and solar energy is subjected to natural limitation of sun light intensity and time. In view of these drawbacks and shortcoming, the present invention aims to provide a novel disk type magnetic generator that is operable to generate electrical power at an extremely low rotational speed and low torque, is economic in building expense, enables continuous operation and can be set in parallel connection in generating power, provides a simple, economic, and stable power supply system, and has low cost for both installation and maintenance, wherein a first embodiment of the disk type magnetic generator (9) according to the present invention (see FIG. 6), whether being configured as a core-included disk type magnetic generator (9) that is composed of a rotor (2) and a stator (1) positioned against each other and connected in series or as a core-free disk type magnetic generator (9) that is composed of two rotors (2) sandwiching a stator (1) that are connected in series, features a number of magnets (22) being mounted to rotor plate(s) (20) in such a way that magnet holes (25) are formed in a single circle and have a number corresponding to that of coil slots (17) that are arranged in a single circle to receive and retain the same number of magnets (22) or a number of magnets (22) being adhesively attached to a surface of rotor plate(s) (20) positioned against a stator plate (10) in a single circle. Besides being of a cylindrical form as mentioned above (for easy insertion into and retention in the magnet holes (25)), the magnets (22) can be magnets (22) in the form of flat plates. A motor-coupled shaft (31) is connected, in series, to a first rotor (2), a stator (1), and a second rotor (2). The stator (1) comprises a stator plate (10) that forms, centrally, a stator plate bore (11) and comprises a number of rotatable coils (12) that are arranged in a single circle. The first rotor (2) and the second rotor (2) comprise two rotor plates (20) each of which forms, centrally, a rotor plate bore (21) and comprises a corresponding number of magnets (22) that are arranged in a single circle to correspond to the number of rotatable coils (12) that are mounted to the stator plate (10) and arranged in a single circle. The first rotor (2) and the second rotor (2) are rotatable in unison with a driven shaft (31). Due to a bearing (3) received and retained in the stator plate bore (11), the stator (1) is kept stationary and enables connection with a power cable (92) for power transmission. Thus, a core-free disk type magnetic generator (9) is provided and is characterized in that the first rotor (2) and the second rotor (2) each have a surface positioned against the stator plate (10) and comprising a corresponding number of rotatable flat-plate magnets (22) that are arranged in a single circle, wherein each of the flat-plate magnets (22) forms an inclination angle (0) with respect to a radius of the rotor plate (20) that extends through a center of mass of the flat-plate magnet (22) and wherein when driven, the shaft (31) causes the rotatable magnets (22) mounted to the first rotor (2) and the second rotor (2) to fast rotate and pass through the coils (12) of the stator (1) to achieve optimum-angle demagnetization without catching the iron core (namely the output waveform being rounded and having no serration wave) (see FIG. 7).

The previous described structure, when applied to a core-included disk type magnetic generator (9), comprises a shaft (31) that is connected, in series, to a rotor (2) and a stator (1). The stator (1) comprises a stator plate (10) forming, centrally, a stator plate bore (11) and having an outer circumference comprising a number of rotatable coils (12) that are arranged in a single circle. Each of the coils (12) has a surface positioned against a rotor plate (20) and provided with one of silicon steel plates (16) that are arranged circumferentially. The rotor (2) comprises a rotor plate (20) forming, centrally, a rotor plate bore (21) and comprising a corresponding number of magnets (22) that are arranged in a single circle and correspond to the number of rotatable coils (12) that are arranged in a single circle along an outer circumference of the stator plate (10), wherein each of the flat-plate magnets (22) forms an inclination angle (0) with respect to a radius of the rotor plate (20) that extends through the center of mass of the flat-plate magnet (22).

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a conventional core-free disk type generator.

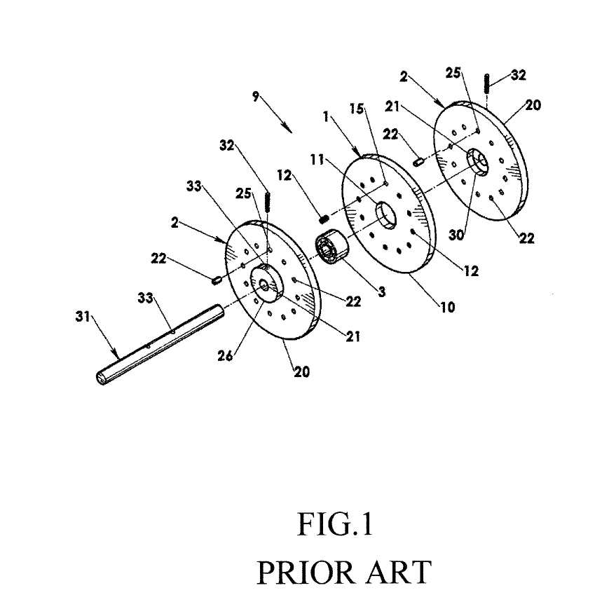

FIG. 2 is a perspective view of assembled stator and rotor of the conventional core-free disk type generator.

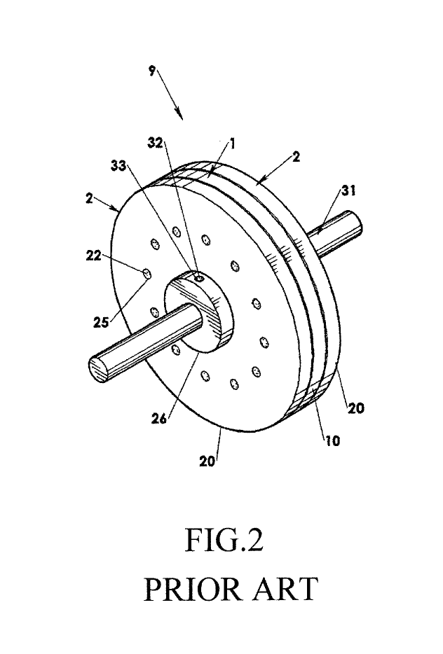

FIG. 3 is a perspective view of the conventional core-free disk type generator in an assembled form.

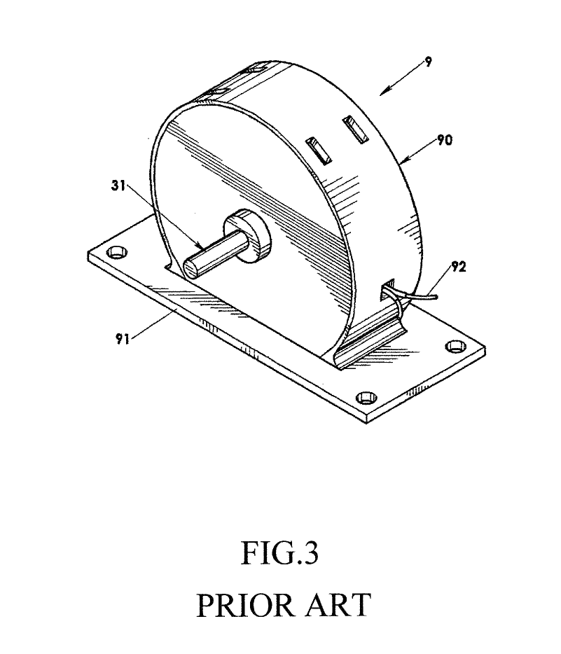

FIG. 4 is an exploded view of a conventional core-included disk type generator.

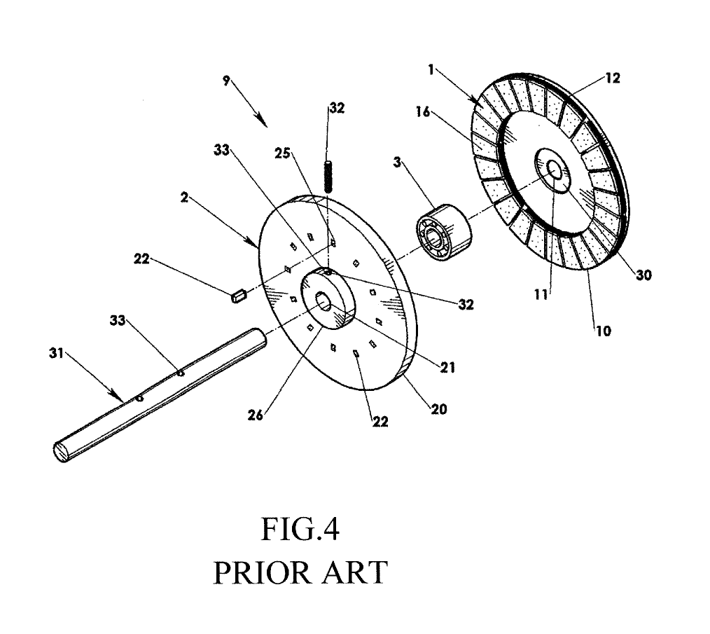

FIG. 5 is a perspective view of assembled stator and rotor of the conventional core-included disk type generator.

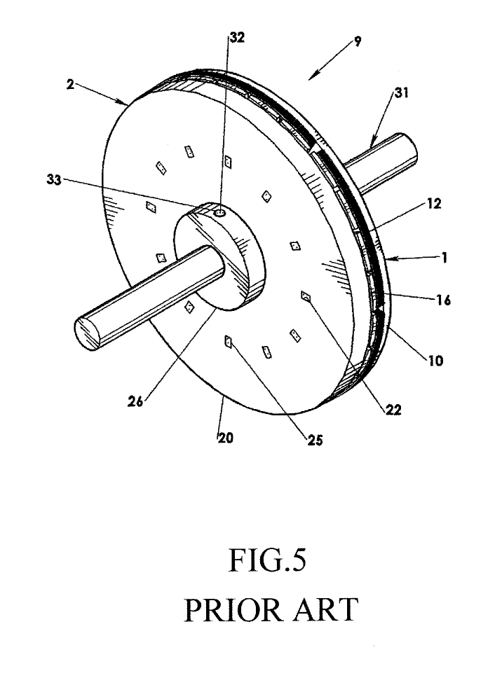

FIG. 6 is a perspective view showing arrangement of flat-plate magnets according to a first embodiment of the present invention.

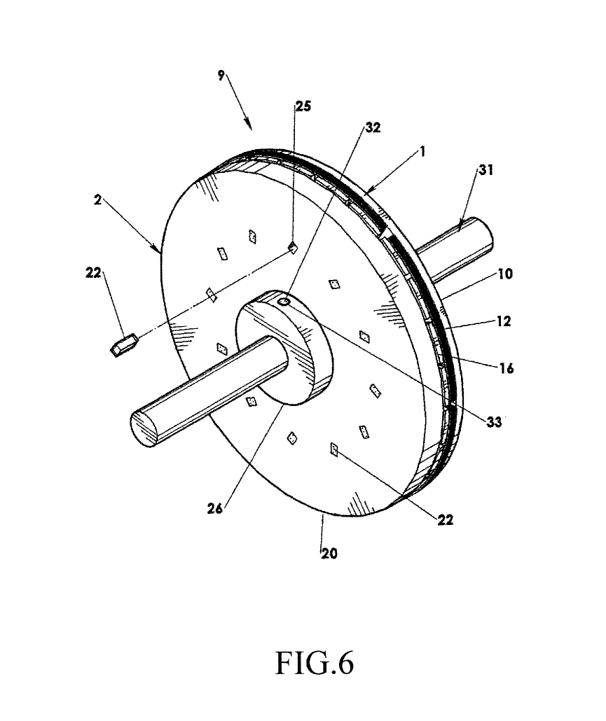

FIG. 7 is a schematic view illustrating angle of the fiat-plate magnets arranged on a rotor plate of FIG. 6.

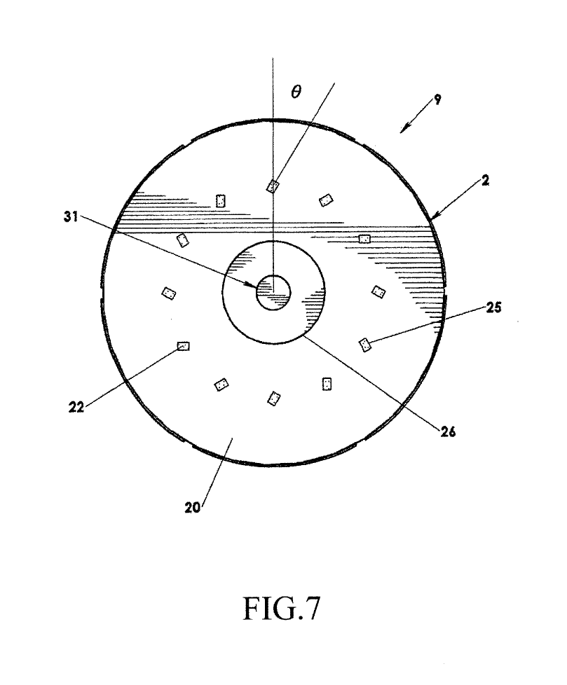

FIG. 8 is an exploded view showing a stator and a rotor having a multi-level arrangement of according to a second (preferred) embodiment of the present invention.

FIG. 9 is a circuit block diagram of the present invention.

FIG. 10 is an exploded view of a third embodiment according to the present invention, wherein a stator and a rotor are each provided with a first expansion ring.

FIG. 11 is an assembled view of FIG. 10.

FIG. 12 is an exploded view of the stator and the rotor of the third embodiment of the present invention that are each additionally provided with a second and a third expansion rings.

FIG. 13 is an assembled view of FIG. 12.

FIG. 14 is a schematic view showing an arrangement of flat-plate magnets on a stator plate according to a fourth embodiment of the present invention, wherein a stator and a rotor are each provided with a first expansion ring.

FIG. 15 is an assembled view of FIG. 14.

FIG. 16 is an exploded view showing a disk type generator according to a fifth embodiment of the present invention additionally provided a weight ring.

FIG. 17 is an assembled view of FIG. 16.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

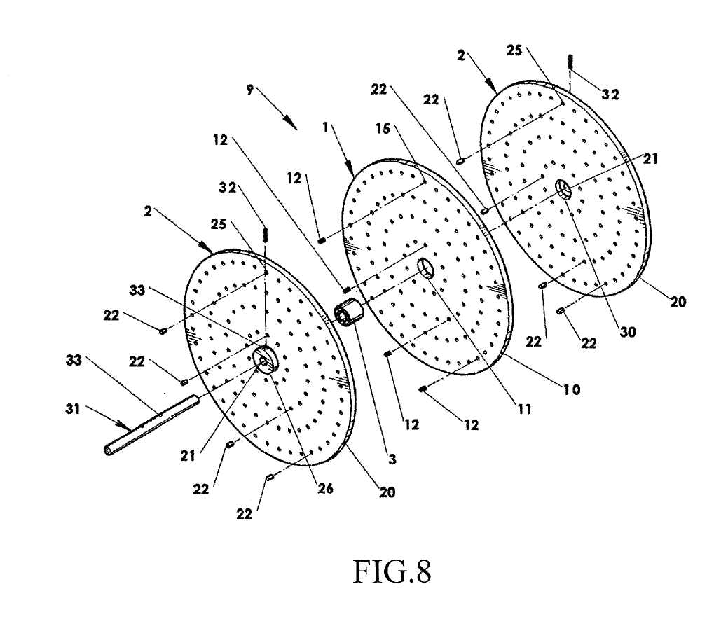

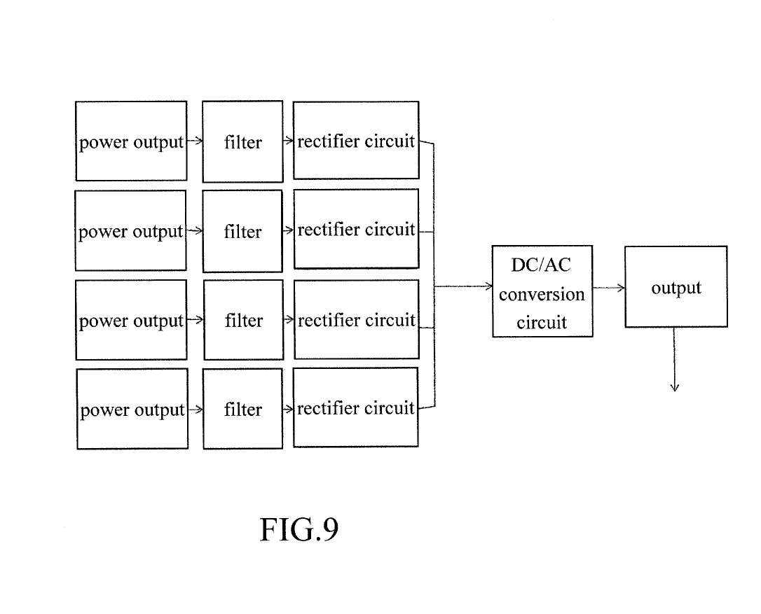

A second (preferred) embodiment of the present invention (see FIG. 8) is a core-free disk type magnetic generator that comprises multiple rotatable groups arranged on the same plate body, which comprises a shaft (31) that is connected, in series, to a first rotor (2), a stator (1), and a second rotor (2). The stator (1) comprises a stator plate (10) that forms, centrally, a stator plate bore (11) and comprises a number of rotatable coils (12) arranged in circles. The first rotor (2) and the second rotor (2) are two rotor plates (20) each forming, centrally, a rotor plate bore (21) and comprising a corresponding number of magnets (22) that are arranged in circles and correspond to the number of rotatable coils (12) that are mounted on the stator plate (10) and arranged in circles. The first rotor (2) and the second rotor (2) are rotatable in unison with a driven shaft (31). Due to bearing (3) received and retained in the central stator plate bore (11), the stator (1) is kept stationary and allows connection with a power cable (92) for power transmission. As such, a core-free disk type magnetic generator (9) is provided and is characterized in that the stator plate (10) of the stator (1) comprises a number of rotatable coils (12) mounted thereto and arranged in groups in the form of at least one concentric circle. The rotor plates (20) of the first rotor (2) and the second rotor (2) are each provided with a corresponding number of magnets (22) that are arranged in concentric circles and correspond to the groups of the number of coils (12) that are mounted on the stator plate (10) of the stator (1) and are arranged in at least one concentric circle, wherein the groups of the number of rotatable coils (12) that are mounted to the stator plate (10) of the stator (1) and are arranged in at least one concentric circle are arranged in such a way that each individual group generates and outputs electrical power that is subjected to filtration by a filter and rectification by rectifier and then supplied through a DC/AC conversion circuit (see FIG. 9).

Embodiment of core-included disk type magnetic generator that comprises multiple rotatable groups arranged on the same plate body comprises a shaft (31) that is connected, in series, to a rotor (2) and a stator (1). The stator (1) comprises a stator plate (10) that forms, centrally, a stator plate bore (11) and comprises a number of rotatable coils (12) that are arranged in at least one concentric circle. Each of the coils (12) has a surface positioned against a rotor plate (20) that is provided with one of silicon steel plates (16) that are distributed circumferentially. The rotor (2) comprises a rotor plate (20) that forms, centrally, a rotor plate bore (21) and comprises a corresponding number of magnets (22) that are arranged in at least one concentric circle and correspond to the number of rotatable coils (12) that are mounted to the stator plate (10) of the stator (1) and arranged in groups in the form of at least one concentric circle.

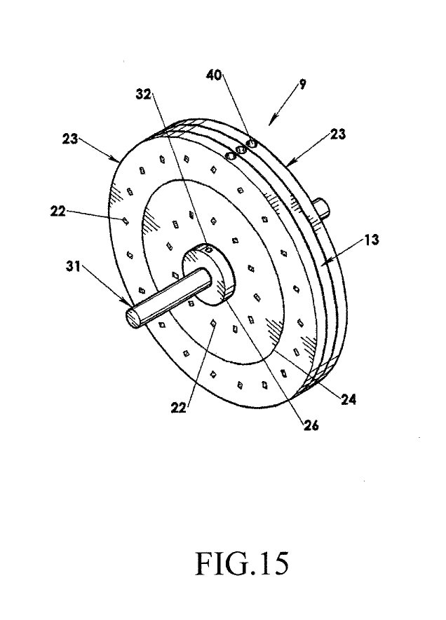

The previously described disk type magnetic generators that comprise multiple rotatable groups arranged on the same plate body are arranged in such a way that the rotor plates (20) of the first rotor (2) and the second rotor (2) are each provided with a number of flat-plate magnets (22) that are arranged in concentric circles, wherein each of the flat-plate magnets (22) forms an inclination angle (0) with respect to a radius of the rotor plate (20) that extends through the center of mass of the flat-plate magnet (22) (see FIG. 15).

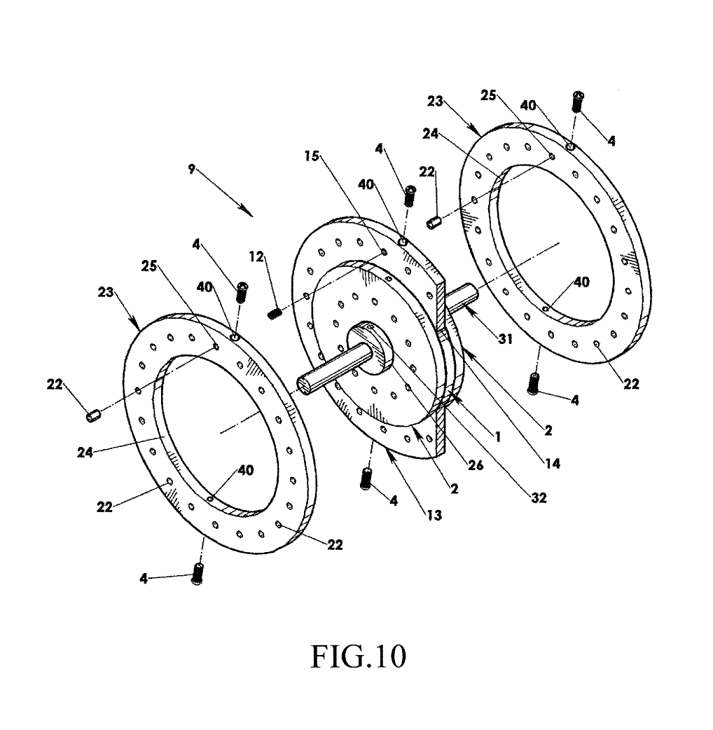

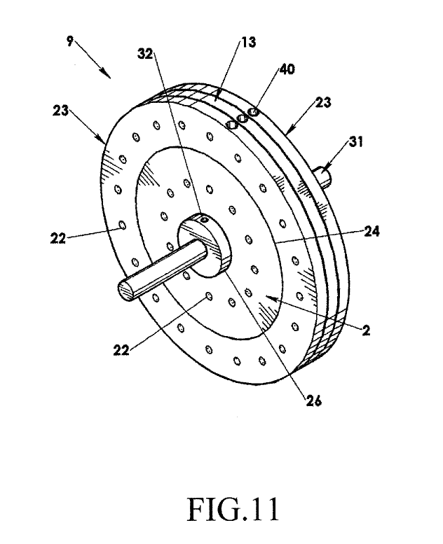

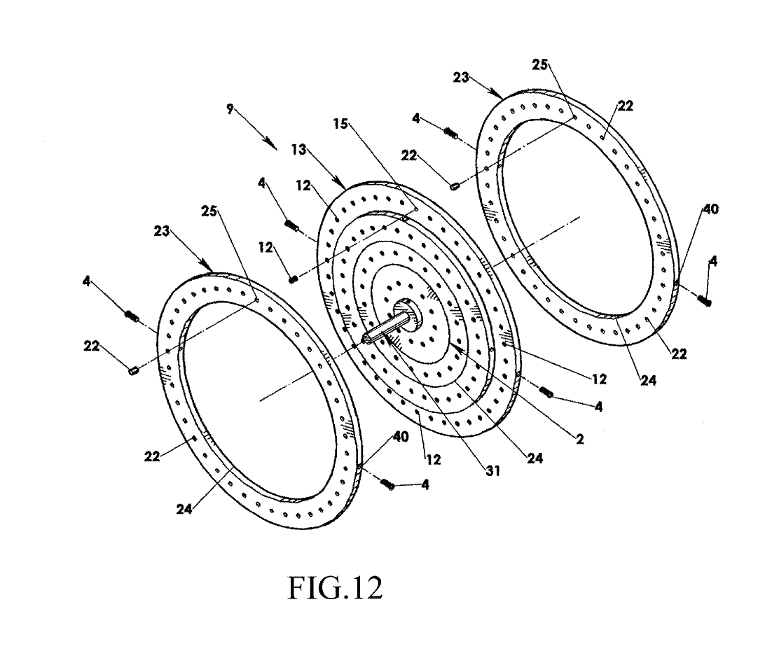

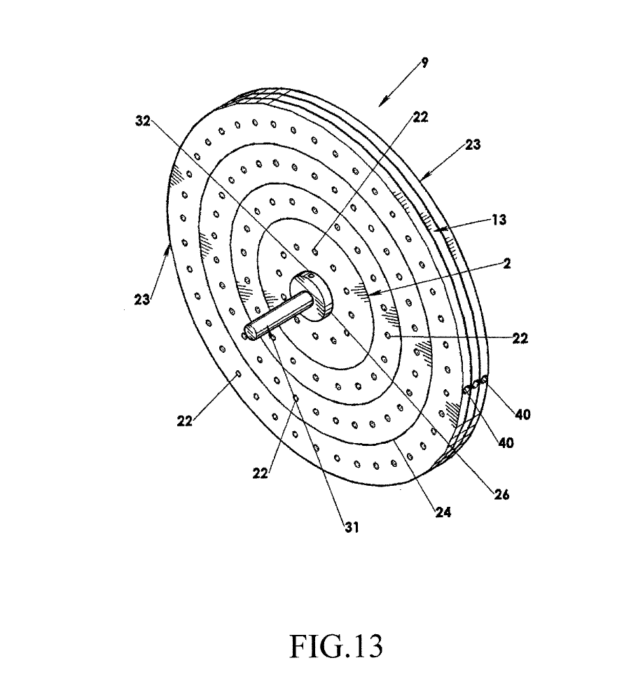

Further, a third embodiment of the present invention (see FIG. 10) is a diameter-expanded core-free disk type magnetic generator (9) that comprises multiple rotatable groups, which comprises a shaft (31) that is connected, in series, to a first rotor (2), a stator (1), and a second rotor (2). The stator (1) comprises a stator plate (10) that forms, centrally, a stator plate bore (11) and comprises a number of rotatable coils (12) arranged in a single circles. The first rotor (2) and the second rotor (2) are two rotor plates (20) each forming, centrally, a rotor plate bore (21) and comprising a corresponding number of magnets (22) that are arranged in a single circle and correspond to the number of rotatable coils (12) that are mounted on the stator plate (10) and arranged in a single circle. The first rotor (2) and the second rotor (2) are rotatable in unison with a driven shaft (31). Due to bearing (3) received and retained in the central stator plate bore (11), the stator (1) is kept stationary and allows connection with a power cable (92) for power transmission. As such, a core-free disk type magnetic generator (9) is provided and is characterized in that the stator plate (10) of the stator (1) comprises at least one rotatable stator expansion ring (13) arranged in a diameter expansion direction. The stator expansion ring (13) comprises a number of rotatable coils (12) that are mounted thereto and arranged in at least one concentric circle. The rotor plates (20) of the rotors (2) are each provided with at least one rotatable rotor expansion ring (23) in a diameter expansion direction. The rotor expansion ring (23) comprises a corresponding number of rotatable magnets (22) that are mounted thereto and arranged in at least one concentric circle. The rotatable connection between the stator expansion ring (13) and the stator plate (10) and between the rotor expansion rings (23) and the rotor plates (20) is such that the ring bodies of the stator expansion ring (13) and the rotor expansion rings (23) are each provided with a number of bolt holes (40) that respectively receive the same number of bolts (4) to extend through a stator ring bore (14) of the stator expansion ring (13) to reach the stator plate (10) and to extend through rotor ring bores (24) of the rotor expansion rings (23) to reach the rotor plates (20). The stator plate (10) of the stator (1) and the stator expansion ring (13) are provided with a number of rotatable coils (12) that are arranged in groups in the form of at least one concentric circle in such a way that each individual group generates and outputs electrical power that is subjected to filtration by a filter and rectification by rectifier and then supplied through a DC/AC conversion circuit (see FIGS. 10-13).

It is certain that the above described structure is applicable to an embodiment of diameter-expanded core-included disk type magnetic generator that comprises multiple rotatable groups, which comprises a shaft (31) that is connected, in series, to a rotor (2) and a stator (1). The stator (1) comprises a stator plate (10) that forms, centrally, a stator plate bore (11) and comprises a number of rotatable coils (12) that are arranged in at least one concentric circle. Each of the coils (12) has a surface positioned against a rotor plate (20) that is provided with one of silicon steel plates (16) that are distributed circumferentially. The rotor (2) comprises a rotor plate (20) that forms, centrally, a rotor plate bore (21) and comprises a corresponding number of rotatable magnets (22) that are arranged in at least one concentric circle and correspond to the number of rotatable coils (12) that are mounted to the stator plate (10) of the stator (1) and arranged in groups in the form of at least one concentric circle. The stator plate (10) of the stator (1) comprises at least one rotatable stator expansion ring (13) arranged in a diameter expansion direction. The stator expansion ring (13) comprises a number of rotatable coils (12) that are mounted thereto and arranged in at least one concentric circle. The rotor plate (20) of the rotor (2) is provided with at least one rotatable rotor expansion ring (23) in a diameter expansion direction. The rotor expansion ring (23) comprises a corresponding number of rotatable magnets (22) that are mounted thereto and arranged in at least one concentric circle. The stator plate (10) of the stator (1) and the stator expansion ring (13) are provided with a number of rotatable coils (12) that are arranged in groups in the form of at least one concentric circle in such a way that each individual group generates and outputs electrical power that is subjected to filtration by a filter and rectification by rectifier and then supplied through a DC/AC conversion circuit.

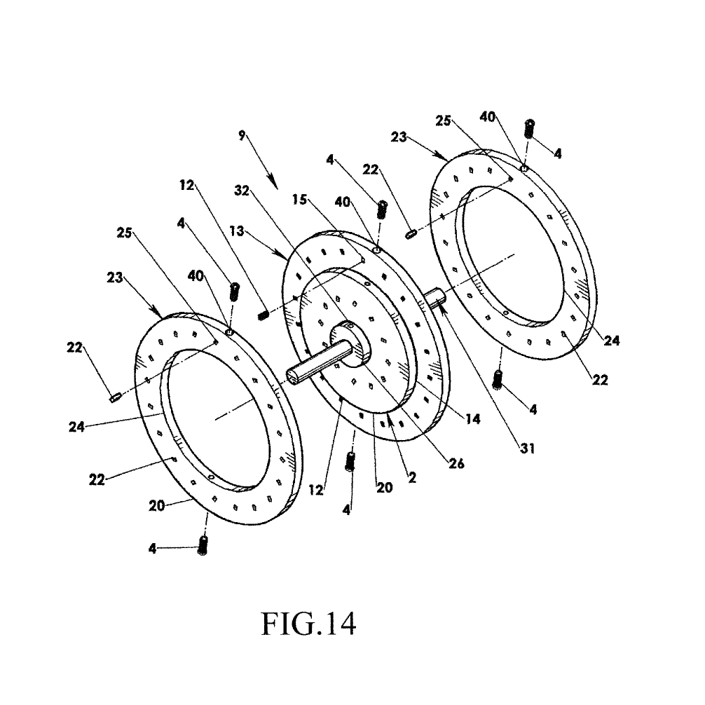

A fourth embodiment of the present invention is diameter-expanded disk type magnetic generator (9) that comprises multiple rotatable groups (see FIG. 14), which comprises rotors (2) comprising rotor plates (20) that each comprise rotatable magnets (22) that are mounted thereto and are arranged in a circle. The rotor plates (20) of the rotors (2) each comprise a rotatable rotor expansion ring (23) arranged in a diameter expansion and comprising rotatable magnets (22) that are mounted thereto and are in the form of flat plates. Each of the magnets (22) forms an inclination angle (0) with respect to a radius of the rotor plate (20) that extends through the center of mass of the magnet (22) (see FIG. 15).

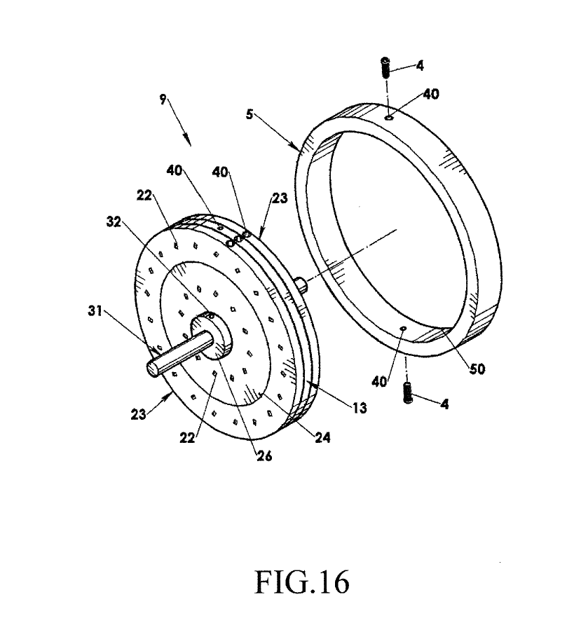

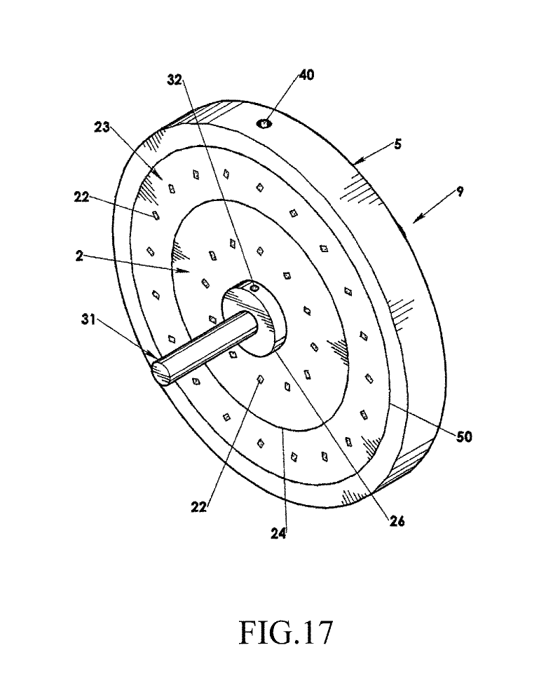

A fifth embodiment of the present invention (see FIG. 16) comprises a weight structure and is applicable to both core-free and core-included disk type magnetic generators (9), wherein a shaft (31) is connected, in series, to a rotor (2) and a stator (1) to form a combined assembly having a diameter expansion direction where at least one rotatable weight ring (5) is arranged. The weight ring (5) comprises a ring body in which a number of bolt holes (40) are formed to receive bolts (4) to extend through a weight ring bore (50) of the weight ring (5) to reach the combined assembly of the rotor (2) and the stator (1) so as to provide a flywheel like rotary inertial effect for the combined assembly of the rotor (2) and the stator (1) of the disk type magnetic generator (9) (see FIG. 17).

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A disk type magnetic generator, comprising a motor-coupled shaft that is connected, in series, to a first rotor, a stator, and a second rotor, the stator comprising a stator plate that forms, centrally, a stator plate bore and comprises a number of rotatable coils that are arranged in a single circle, the first rotor and the second rotor comprising two rotor plates each of which forms, centrally, a rotor plate bore and comprises a corresponding number of magnets that are arranged in a single circle to correspond to the number of rotatable coils that are mounted to the stator plate and arranged in a single circle, the first rotor and the second rotor being rotatable in unison with a driven shaft, whereby due to a bearing received and retained in the stator plate bore, the stator is kept stationary and enables connection with a power cable for power transmission so as to provide a core-free disk type magnetic generator that is characterized in that the first rotor and the second rotor each have a surface positioned against the stator plate and comprising a corresponding number of rotatable flat-plate magnets that are arranged in a single circle, wherein each of the flat-plate magnets forms an inclination angle with respect to a radius of the rotor plate that extends through a center of mass of the flat-plate magnet. When driven, the shaft causes the rotatable magnets mounted to the first rotor and the second rotor to fast rotate and pass through the coils of the stator to achieve optimum-angle demagnetization without catching the iron core.

2. The disk type magnetic generator according to claim 1, wherein the disk type magnetic generator that comprises an iron core is structured by comprising a shaft that is connected, in series, to a rotor and a stator, the stator comprising a stator plate forming, centrally, a stator plate bore and having an outer circumference comprising a number of rotatable coils that are arranged in a single circle, each of the coils having a surface positioned against a rotor plate and provided with one of silicon steel plates that are arranged circumferentially, the rotor comprising a rotor plate forming, centrally, a rotor plate bore and comprising a corresponding number of magnets that are arranged in a single circle and correspond to the number of rotatable coils that are arranged in a single circle along an outer circumference of the stator plate, wherein each of the flat-plate magnets forms an inclination angle with respect to a radius of the rotor plate that extends through the center of mass of the flat-plate magnet.

3. A disk type magnetic generator, which is a core-free disk type magnetic generator that comprises multiple rotatable groups arranged on a same plate body, which comprises a shaft that is connected, in series, to a first rotor, a stator, and a second rotor the stator comprising a stator plate that forms, centrally, a stator plate bore and comprises a number of rotatable coils arranged in circles, the first rotor and the second rotor being two rotor plates each forming, centrally, a rotor plate bore and comprising a corresponding number of magnets that are arranged in circles and correspond to the number of rotatable coils that are mounted on the stator plate and arranged in circles, the first rotor and the second rotor being rotatable in unison with a driven shaft, whereby due to bearing received and retained in the central stator plate bore, the stator is kept stationary and allows connection with a power cable for power transmission so as to provide a core-free disk type magnetic generator that is characterized in that the stator plate of the stator comprises a number of rotatable coils mounted thereto and arranged in groups in the form of at least one concentric circle, the rotor plates of the first rotor and the second rotor are each provided with a corresponding number of magnets that are arranged in concentric circles and correspond to the groups of the number of coils that are mounted on the stator plate of the stator and are arranged in at least one concentric circle, wherein the groups of the number of rotatable coils that are mounted to the stator plate of the stator and are arranged in at least one concentric circle are arranged in such a way that each individual group generates and outputs electrical power that is subjected to filtration by a filter and rectification by rectifier and then supplied through a DC/AC conversion circuit.

4. The disk type magnetic generator according to claim 3, which is made in the form of a core-included disk type magnetic generator that comprises multiple rotatable groups arranged on a same plate body, which comprises an arrangement of at least one group of circularly arranged coils and magnets that is applicable to a core-included disk type magnetic generator, which is structured by comprising a shaft that is connected, in series, to a rotor and a stator, the stator comprising a stator plate that forms, centrally, a stator plate bore and comprises a number of rotatable coils that are arranged in at least one concentric circle, each of the coils having a surface positioned against a rotor plate that is provided with one of silicon steel plates that are distributed circumferentially, the rotor comprising a rotor plate that forms, centrally, a rotor plate bore and comprises a corresponding number of magnets that are arranged in at least one concentric circle and correspond to the number of rotatable coils that are mounted to the stator plate of the stator and arranged in groups in the form of at least one concentric circle.

5. The disk type magnetic generator according to claim 3, wherein the disk type magnetic generator that comprises multiple rotatable groups arranged on the same plate body is arranged in such a way that the rotor plates of the first rotor and the second rotor are each provided with a number of flat-plate magnets that are arranged in concentric circles, wherein each of the flat-plate magnets forms an inclination angle with respect to a radius of the rotor plate that extends through the center of mass of the flat-plate magnet.

6. The disk type magnetic generator according to claim 4, wherein the disk type magnetic generator that comprises multiple rotatable groups arranged on the same plate body is arranged in such a way that the rotor plates of the first rotor and the second rotor are each provided with a number of flat-plate magnets that are arranged in concentric circles, wherein each of the flat-plate magnets forms an inclination angle with respect to a radius of the rotor plate that extends through the center of mass of the flat-plate magnet.

7. A disk type magnetic generator, which is a diameter-expanded core-free disk type magnetic generator that comprises multiple rotatable groups, which comprises a shaft that is connected, in series, to a first rotor, a stator, and a second rotor, the stator comprising a stator plate that forms, centrally, a stator plate bore and comprises a number of rotatable coils arranged in a single circles, the first rotor and the second rotor being two rotor plates each forming, centrally, a rotor plate bore and comprising a corresponding number of magnets that are arranged in a single circle and correspond to the number of rotatable coils that are mounted on the stator plate and arranged in a single circle, the first rotor and the second rotor being rotatable in unison with a driven shaft, whereby due to bearing received and retained in the central stator plate bore, the stator is kept stationary and allows connection with a power cable for power transmission so as to provide a core-free disk type magnetic generator that is characterized in that the stator plate of the stator comprises at least one rotatable stator expansion ring arranged in a diameter expansion direction, the stator expansion ring comprising a number of rotatable coils that are mounted thereto and arranged in at least one concentric circle, the rotor plates of the rotors being each provided with at least one rotatable rotor expansion ring in a diameter expansion direction, the rotor expansion ring comprising a corresponding number of rotatable magnets that are mounted thereto and arranged in at least one concentric circle, the stator plate of the stator and the stator expansion ring being provided with a number of rotatable coils that are arranged in groups in the form of at least one concentric circle in such a way that each individual group generates and outputs electrical power that is subjected to filtration by a filter and rectification by rectifier and then supplied through a DC/AC conversion circuit.

8. The disk type magnetic generator according to claim 7, which is a diameter-expanded core-included disk type magnetic generator that comprises multiple rotatable groups, which comprises a shaft that is connected, in series, to a rotor and a stator, the stator comprising a stator plate that forms, centrally, a stator plate bore and comprises a circle, each of the coils having a surface positioned against a rotor plate that is provided with one of silicon steel plates that are distributed circumferentially, the rotor comprising a rotor plate that forms, centrally, a rotor plate bore and comprises a corresponding number of rotatable magnets that are arranged in at least one concentric circle and correspond to the number of rotatable coils that are mounted to the stator plate of the stator and arranged in groups in the form of at least one concentric circle, the stator plate of the stator comprising at least one rotatable stator expansion ring arranged in a diameter expansion direction, the stator expansion ring comprising a number of rotatable coils that are mounted thereto and arranged in at least one concentric circle, the rotor plate of the rotor being provided with at least one rotatable rotor expansion ring in a diameter expansion direction, the rotor expansion ring comprising a corresponding number of rotatable magnets that are mounted thereto and arranged in at least one concentric circle, the stator plate of the stator and the stator expansion ring being provided with a number of rotatable coils that are arranged in groups in the form of at least one concentric circle in such a way that each individual group generates and outputs electrical power that is subjected to filtration by a filter and rectification by rectifier and then supplied through a DC/AC conversion circuit.

9. The disk type magnetic generator according to claim 7, which is a diameter-expanded disk type magnetic generator that comprises multiple rotatable groups, which comprises rotors comprising rotor plates that each comprise rotatable magnets that are mounted thereto and are arranged in a circle, the rotor plates of the rotors each comprising a rotatable rotor expansion ring arranged in a diameter expansion and comprising rotatable magnets that are mounted thereto and are in the form of flat plates, each of the magnets forming an inclination angle with respect to a radius of the rotor plate that extends through the center of mass of the magnet.

10. The disk type magnetic generator according to claim 8, which is a diameter-expanded disk type magnetic generator that comprises multiple rotatable groups, which comprises rotors comprising rotor plates that each comprise rotatable magnets that are mounted thereto and are arranged in a circle, the rotor plates of the rotors each comprising a rotatable rotor expansion ring arranged in a diameter expansion and comprising rotatable magnets that are mounted thereto and are in the form of flat plates, each of the magnets forming an inclination angle with respect to a radius of the rotor plate that extends through the center of mass of the magnet.

11. The disk type magnetic generator according to claim 7, wherein a shaft is connected, in series, to a rotor and a stator to form a combined assembly having a diameter expansion direction where at least one rotatable weight ring is arranged, the weight ring comprising a ring body in which a number of bolt holes are formed to receive bolts to extend through a weight ring bore of the weight ring to reach the combined assembly of the rotor and the stator so as to provide a flywheel like rotary inertial effect for the combined assembly of the rotor and the stator of the disk type magnetic generator.

12. The disk type magnetic generator according to claim 8, wherein a shaft is connected, in series, to a rotor and a stator to form a combined assembly having a diameter expansion direction where at least one rotatable weight ring is arranged, the weight ring comprising a ring body in which a number of bolt holes are formed to receive bolts to extend through a weight ring bore of the weight ring to reach the combined assembly of the rotor and the stator so as to provide a flywheel like rotary inertial effect for the combined assembly of the rotor and the stator of the disk type magnetic generator.
